(19) United States
(12) Patent Application Publication
(10) Pub. No.: US 2013/0237152 A1
(43) Pub. Date: Sep. 12, 2013

(54) METHODS AND SYSTEMS FOR HARDWARE AND SOFTWARE RELATED TO A NEAR FIELD COMMUNICATIONS TASK LAUNCHER

(71) Applicants: Kulveer Taggar, San Francisco, CA (US); Joshua Krohn, Plainfield, IL (US); Omar Seyal, San Francisco, CA (US); Srinivas Panguluri, San Francisco, CA (US)

(72) Inventors: Kulveer Taggar, San Francisco, CA (US); Joshua Krohn, Plainfield, IL (US); Omar Seyal, San Francisco, CA (US); Srinivas Panguluri, San Francisco, CA (US)

(21) Appl. No.: 13/599,923

(22) Filed: Aug. 30, 2012

Related U.S. Application Data
(60) Provisional application No. 61/609,231, filed on Mar. 9, 2012.

(51) Int. Cl. H04B 5/02

(52) U.S. Cl. 455/41.1

(57) ABSTRACT

The present invention provides a system implemented by a processor of a mobile device. The system includes a receiver module for receiving a signal from a near field communication (NFC) tag. The system also includes an interface module for processing the signal and identifying at least one action to be performed, and an action module for performing the at least one action. A method is provided for controlling a mobile device using an NFC system. The method includes receiving at a receiver of the mobile device a signal from an NFC tag and identifying from the signal at least one action to be performed. The method also includes performing the at least one action. A non-transitory computer readable medium having recorded thereon a program is provided. The program causes a computer to perform a method for controlling a mobile device using an NFC system.

### CROSS REFERENCE TO RELATED APPLICATIONS

This Non-Provisional U.S. Patent Application claims the benefit of U.S. Provisional Patent Application Ser. No. 61/609,231 filed on Mar. 9, 2012, entitled “METHODS AND SYSTEMS FOR NEAR FIELD COMMUNICATIONS” which is hereby incorporated by reference herein in its entirety.

### FIELD OF THE INVENTION

The present invention relates generally to Near Field Communication (NFC) devices, and in particular relates to systems and methods for performing tasks on a mobile device using an NFC tag, programming NFC tags, and dynamic NFC systems.

### BACKGROUND

NFC is a wireless protocol that provides a method of communicating between a tag and reader. NFC may also be used to manage communication between two mobile devices and/or a mobile device and a tag. The communication is by radio and is prompted by contact or close proximity (usually less than 4 cm). For example, the Clipper™ transit system in San Francisco uses NFC.

NFC typically uses an initiating device and a target. The initiating device generates a radio frequency (RF) field that prompts an RF response signal from the target. The target may be a tag or another mobile device. The RF field may provide power to the target to enable the target to emit the response signal.

NFC tags may be rewriteable and may store and communicate any of various types of data.

### SUMMARY OF THE INVENTION

According to exemplary embodiments, the present invention provides a system implemented by a processor of a mobile device. The system includes a receiver module for receiving a signal from a near field communication (NFC) tag. The system also includes an interface module for processing the signal and identifying at least one action to be performed, and an action module for performing the at least one action.

A method is provided for controlling a mobile device using a near field communication (NFC) system. The method includes receiving at a receiver of the mobile device a signal from an NFC tag, and identifying from the signal at least one action to be performed. The method also includes performing the at least one action.

A non-transitory computer readable medium having recorded thereon a program is provided. The program when executed causes a computer to perform a method for controlling a mobile device using a near field communication (NFC) system. The method includes receiving an input indicating at least one action to be performed when a proximity event is identified. The proximity event is when a receiver of the mobile device is proximate to an NFC tag. The method also includes identifying the proximity event by the receiver of the mobile device, and performing the at least one action when the receiver identifies the proximity event.

These and other advantages of the present invention will be apparent when reference is made to the accompanying drawings and the following description.

### BRIEF DESCRIPTION OF THE DRAWINGS

FIG. 1 illustrates an exemplary mobile device for practicing aspects of the present technology.

FIG. 2 illustrates an exemplary system including an NFC tag for practicing aspects of the present technology.

FIG. 3 is a flow chart illustrating an exemplary method for practicing aspects of the present technology.

FIGS. 4A to 4G are screenshots of a graphical user interface for interacting with an exemplary device for practicing aspects of the present technology.

FIG. 5 an exemplary computing device that may be used to implement an embodiment of the present technology.

### DETAILED DESCRIPTION OF EXEMPLARY EMBODIMENTS

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated. According to exemplary embodiments, the present technology relates generally to Near Field Communications (NFC). More specifically, the present invention provides a system and method for using NFC tags to initiate settings modifications or run applications in a mobile device.

The present technology, which may be referred to as an NFC Task Launcher herein, provides a program that allows a user to record tasks on a phone and program them to NFC tags (also referred to as tags or a tag). The NFC tags may then be used to automate tasks. An NFC Task Launcher makes NFC useful for everyday life. A single NFC tag may be used to configure a phone, or perform actions immediately when the NFC tag is read by the phone.

For example, a tag in a user's car, or in a docking station in the user's car, may be scanned to initiate the following actions: turn on Bluetooth; turn off Wifi; and start up a music application. Similarly, a tag on a nightstand may be scanned to initiate the following actions: set ringer to vibrate; dim the display; and set an alarm. Likewise, a tag near a front door may be scanned, by the occupant or a guest, to initiate the following actions: start up Wifi and automatically connect to a home network. In this manner, guests may avoid having to enter wireless network information manually.

A command or commands may be written directly to the tag. The NFC tags are able to command any device with the NFC Task Launcher application installed. Each user that scans the NFC tag will have the same actions performed on their device, except in the case of switch tags, as discussed herein. Tasks may be custom configured, and the NFC Task Launcher application may be compatible with a task application. Actions can be performed in any order and in any combination.

An exemplary list of possible action categories includes: tasks; switch tasks (toggle between two saved tasks (or task sets) using one NFC tag); vCard tags; smart URL tags; text tags; and URI tags (Tel, SMS, Mailto).

An exemplary list of possible actions includes: enable, disable, or toggle between enabled and disabled for Wifi and/or Bluetooth; enable Bluetooth discoverability; enable, disable, or toggle between enabled and disabled for airplane mode; launch any installed application; connect to any known SSID; configure a new Wifi connection and connect; configure and enable a portable Hotspot; enable or disable an auto-synchronization process; set a display brightness; enable or disable auto brightness; launch any task from a task application (for example, Tasker); change phone ringtone; change phone notification tone; change ringer mode (e.g. to normal, silent, or vibrate); change ringer, media, alarm, or notification volume; set the alarm (either for a fixed time or for fixed interval in the future); check in using Google Latitude™, Foursquare™, or Facebook™; start or stop media playback; and send a tweet on Twitter™.

A widget may be included to show the last profile applied (or actions performed) as well as to launch the NFC Task Launcher application.

The NFC Task Launcher application may be used with NFC Forum Type 1, Type 2 and Type 3 tags, as well as third party NFC enabled tags (for instance the MIFARE Classic™, DESFire™, Ultralight™ and Ultralight C™)

Certain permissions may be required from the phone in order to perform certain tasks initiated by scanning an NFC tag using a phone running the NFC Task Launcher application. Permissions may be required to: access the NFC device; control the Bluetooth radio (on/off/discoverable); read contacts to create vCards; for vibration notification; detect current Wifi radio state and alter Wifi radio; enable/disable airplane mode; update Auto Sync settings; read bookmarks when creating a URL based tag; check Android Licensing service; run a task application integration; set an alarm from a tag; request authorizing credentials for Latitude™ and communicate via the Latitude™ API; and enable Latitude™ to get current network location. A permissions list may be required only for specific operating systems, for instance the Android™ operating system.

During tag creation, a user opens the application and is presented with a user interface (UI) that enables the user to create a tag aimed at controlling the device. This UI walks the user though creating a series of ordered commands that will be executed when the tag is read. When the user is finished creating the list of actions to be performed, this information is written to a tag. At this point, any device with the application installed can read this tag and the same series of actions will be performed.

When reading a tag, the NFC Task Launcher application detects the specific type of tag and reads the data. The tag contents are then passed off to a parser. The parser dissects the long command string into a series of commands to be executed and then executes those commands sequentially. Each command describes changing a setting on the device or performing a specific action. A universally unique identifier (UUID) may be transmitted by the tag during a read operation, but may not be used by the NFC Task Launcher application.

A Tag Builder interface serves to provide an easy to use user interface so that users can create their own single Task tags containing one set of instructions. Users also may create a switch tag that contains two task sets that will be run in an opposing fashion. A switch tag enables the user to use a single tag to describe two distinct sets of actions to be executed (one on the first read and one on the second read).

A switch tag may be used to assign two or more task sets to a single NFC tag, so that upon a first read by a first mobile device, a first command set is performed. On a second read by the same mobile device, without an intervening read (or a timeout, if applicable), then a second command set is performed. The mobile device identifies a switch tag by the special syntax separating the first and second (or more) command sets, and identifies that the same NFC tag is being read by identifying that the entire command set is identical to a command set previously received. Identification of an NFC tag is done based on the instruction set on the tag. The NFC tag transmits both sets of commands, and the mobile device selects between the two sets for a command set to be performed based on whether a previous read from that tag has been made or not.

A switch tag may operate the same way regardless of the device being used to read it. In other words, if device “A” reads the tag, then device “B” reads it, both devices perform the first set of commands on the switch tag, assuming neither has previously read that tag. The switch tag operates individually on each device, and the state is tracked on the mobile device and mapped by the command string. The switch tag stores two command strings, and the mobile device or devices track prior usage to determine which command set to perform. For example, if the mobile device has never read this tag it will execute the first command set. If the mobile device has read this tag and has last executed the first command set, the mobile device will execute the second command set, and otherwise it will execute the first command set.

It is possible to have three or more sets of commands on a switch tag. However, the binary switch tag has the advantage of defining opposing or entry/exit command sets.

Once created, an NFC tag can then be read by any other device that has the NFC Task Launcher application. An NFC tag programmed with respect to one type of device (e.g. Android™), will work with other device types (e.g. iPhone™). The parser is adapted for use with various operating systems. The called methods that perform each action using the new OS's APIs may need to be updated, and the parser may need to be adapted to port it to the language of the new operating system (OS), for example, Object C for the iPhone™, C++ for Symbian™, etc. The NFC Task Launcher application is easily used cross-platform and is not restricted to any OS or class of devices, and even can be ported to a desktop personal computer with an NFC reader.

The present technology uses a unique syntax to compress many actions into a small file size, and then uses a parser to expand this. A feature that ties the tag builder and tag reader together is a syntax that describes individual commands and allows commands to be chained together to form a sequence of commands or “actions” to be performed. This syntax can be written to any NFC tag and allows any device for which a parser has been written, whether it is an Android™ handset, a Windows™ handset, a desktop personal computer with an NFC reader, or any other device, to read the same series of actions and perform all actions compatible or implemented on that device.

The syntax may include a separator between the first and second command sets on a switch tag. A single command may be an action indicator and then a series of sub arguments separated by colons (the number of which is variable). For example: “E:I1” enables Wifi; “T:I7” toggles GPS; and “C:HomeNetwork:1:MyWifiKey” sets up a Wifi connection for the access point “HomeNetwork” using WPA and the key “MyWifiKey”. These individual commands may be chained together using the semi-colon as a delimiter to form a command set, as follows: “EI1;TI1;C:HomeNetwork:1:MyWifiKey”. This command string may be written to the tag.

The parser takes the payload of the NFC tag and extracts the command string. The parser then breaks that command string down into a series of individual commands. This set of individual commands is then examined by the parser. The parser will loop over an array of commands and break each single command down into its own series of values comprised of a single operation and a variable number of arguments. This operation and the following arguments are what identify which method is then used to perform the described action with the arguments providing the necessary variable data such as configuration data to complete the action. An example operation would be Enable (E) and an example argument would be Wifi (I1).

A timeout may be used in switch tag operation to reset the mobile device to the first command no matter whether the second command has been executed. For example, a mobile device using a switch tag may time out overnight, therefore starting each new day with a first command set being performed in response to a first read of the day.

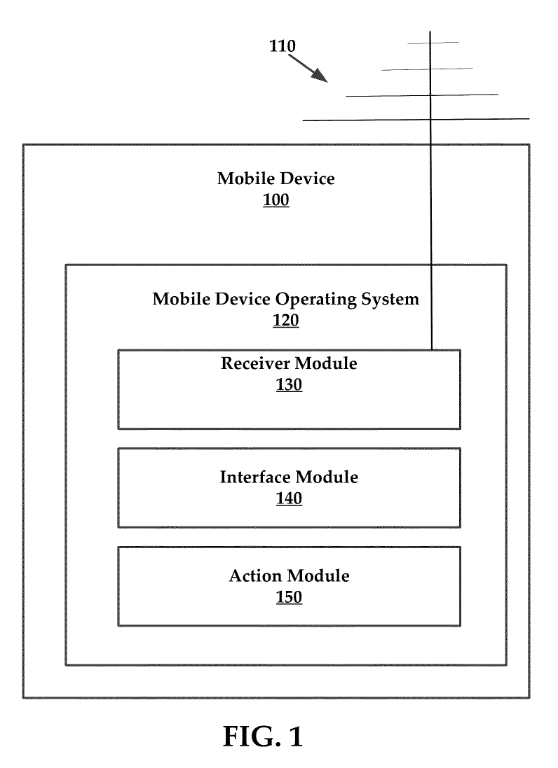

FIG. 1 illustrates an exemplary mobile device 100 for practicing aspects of the present technology. Mobile device 100 includes antenna 110 that operates in a radio frequency. Mobile device 100 also includes mobile device operating system 120 that runs on a processor of mobile device 100. Mobile device operating system 120 includes receiver module 130 that is electronically coupled to antenna 110. Mobile device operating system 120 also includes interface module 140 and action module 150.

In operation, receiver module 130 receives a signal from a near field communication (NFC) tag via antenna 110. Interface module 140 processes the signal and identifies at least one action to be performed by mobile device 100 and/or mobile device operating system 120. This function includes parsing the command, as described herein. Action module 150 performs the at least one action, which may be any of the actions identified herein, or any other appropriate action within a mobile device.

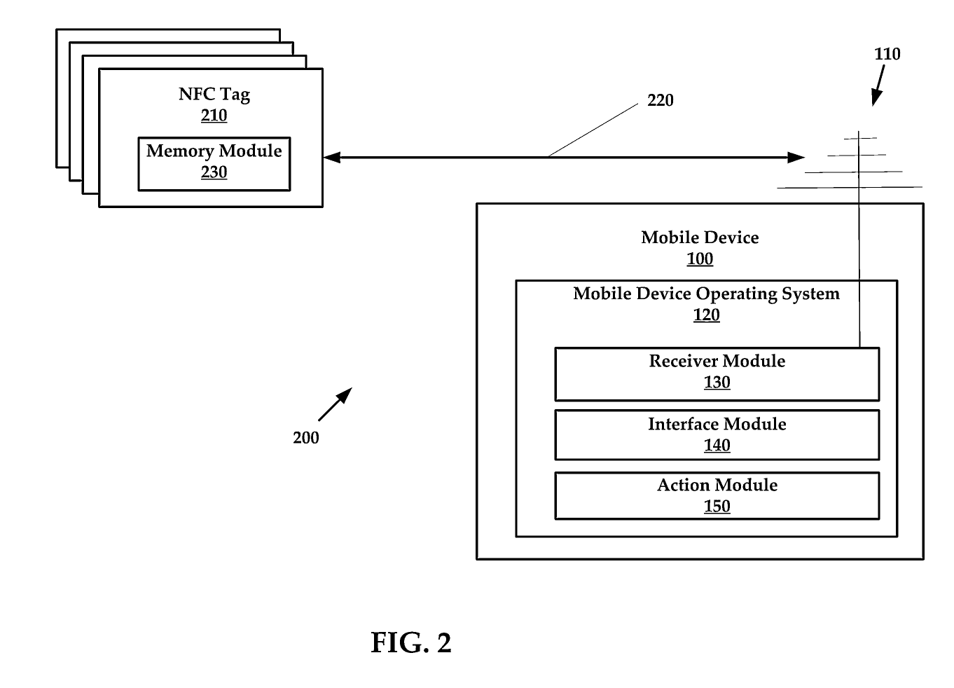

FIG. 2 illustrates system 200 including NFC tag 210 and mobile device 100. NFC tag 210 includes memory module 230, which may be used to store a command, which may include one or more subcommands. Mobile device 100 includes antenna 110 that operates in a radio frequency. Mobile device 100 transmits an initiation or interrogation signal via RF transmission 220 to NFC tag 210. In response, NFC tag 210 transmits RF transmission 220 to mobile device 100. Mobile device 100 also includes mobile device operating system 120 that runs on a processor of mobile device 100. Mobile device operating system 120 includes receiver module 130 that is electronically coupled to antenna 110. Mobile device operating system 120 also includes interface module 140 and action module 150.

Receiver module 130 may receive a second signal from the NFC tag after the first signal and without an intervening signal being received. Interface module 140 may process the second signal and identify at least one second action to be performed. Action module 150 may perform the at least one second action. The signal and the second signal may have identical content, and the identical content may include a command corresponding to the at least one action and a second command corresponding to the at least one second action. The command and the second command may be separated by a command syntax break, which may be a comma, colon, semicolon, period, space or any other appropriate syntax break. Interface module 140 may parse the identical content into the command and the second command using the command syntax break. The second signal may be identified as being received after the signal and without the intervening signal, in which case action module 150 may perform the at least one second action.

The at least one action may include adjusting a setting of mobile device 100 and/or mobile device operating system 120 and/or executing an application on mobile device 100 and/or mobile device operating system 120. Mobile device 100 and/or mobile device operating system 120 may also include a programming module for identifying the at least one action and writing a command corresponding to the at least one action to an NFC tag. Alternatively, the command may be written to the NFC tag by a second mobile device. More than one mobile device may be able to read an NFC tag programmed by one mobile device, and each of the mobile devices reading the NFC tag may perform the same actions programmed into the command line of the NFC tag.

The system may be implemented in a cloud-based computing environment, and in particular, an NFC Task Launcher may be distributed to mobile devices via a Wifi, LAN, WLAN, and/or cellphone network coupling to a cloud-based server. A cloud-based computing environment is a resource that typically combines the computational power of a large grouping of processors and/or that combines the storage capacity of a large grouping of computer memories or storage devices.

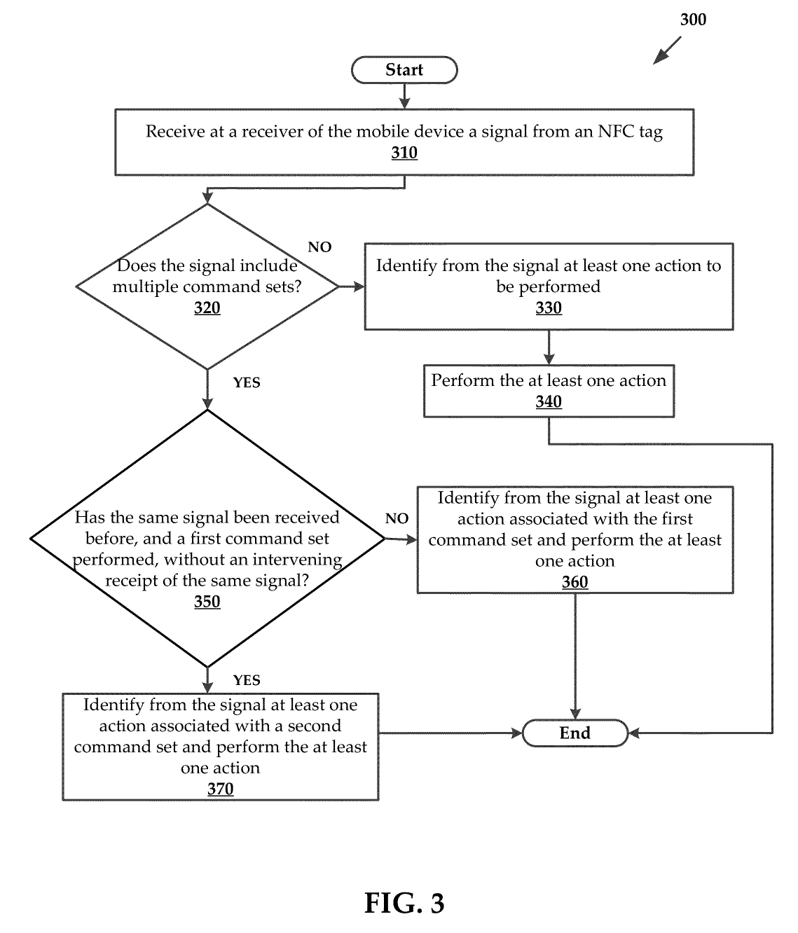

FIG. 3 illustrates method 300 for controlling a mobile device using a near field communication (NFC) system. Method 300 starts at a start oval and proceeds to operation 310, which indicates to receive at a receiver of the mobile device a signal from an NFC tag. From operation 310, the flow proceeds to decision 320, which asks whether the signal includes multiple command sets. If the response to decision 320 is negative, the flow in method 300 proceeds to operation 330, which indicates to identify from the signal at least one action to be performed. From operation 330, the flow proceeds to operation 340, which indicates to perform the at least one action. From operation 340, the flow proceeds to an end oval.

If the response to decision 320 is affirmative, the flow in method 300 proceeds to decision 350, which asks whether the same signal has been received before, and a first command set performed, without an intervening receipt of the same signal. If the response to decision 350 is negative, the flow in method 300 proceeds to operation 360, which indicates to identify from the signal at least one action associated with a first command set and perform the at least one action. From operation 360, the flow proceeds to an end oval. If the response to decision 350 is affirmative, the flow in method 300 proceeds to operation 370, which indicates to identify from the signal at least one action associated with a second command set and perform the at least one action. From operation 370, the flow proceeds to an end oval.

The method may include receiving a second signal from the NFC tag, and the second signal may be received after the signal and without an intervening signal being received. The method may further include processing the second signal and identifying at least one second action to be performed, and performing the at least one second action. The signal and the second signal may include identical content. The identical content may include a command corresponding to the at least one action and a second command corresponding to the at least one second action. The command and the second command may be separated by a command syntax break, and the method further may include parsing the identical content into the command and the second command using the command syntax break. When the second signal is identified as being received after the signal and without the intervening signal, the at least one second action may be performed.

The at least one action may include adjusting a setting of the mobile device and/or executing an application on the mobile device. The method may include identifying the at least one action and writing a command line comprising the at least one action to the NFC tag. A command corresponding to the at least one action may be written to the NFC tag by a second mobile device. In this manner, two mobile devices may read the same tag and perform the same actions, even though only one of the mobile devices (or another mobile device) was used to program the NFC tag.

The method may include receiving a second input indicating at least one second action to be performed when a second proximity event is identified. The second proximity event may be when the receiver of the mobile device is proximate to the NFC tag. The second proximity event may occur after the first proximity event and without an intervening proximity event. The method may also include identifying the second proximity event by the receiver of the mobile device, and performing the at least one second action when the receiver identifies the proximity event.

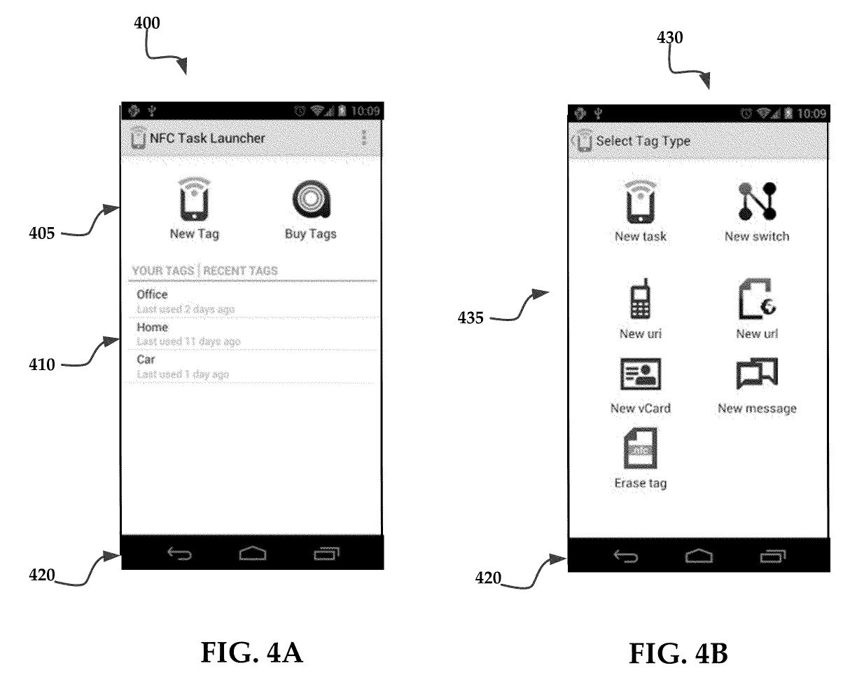

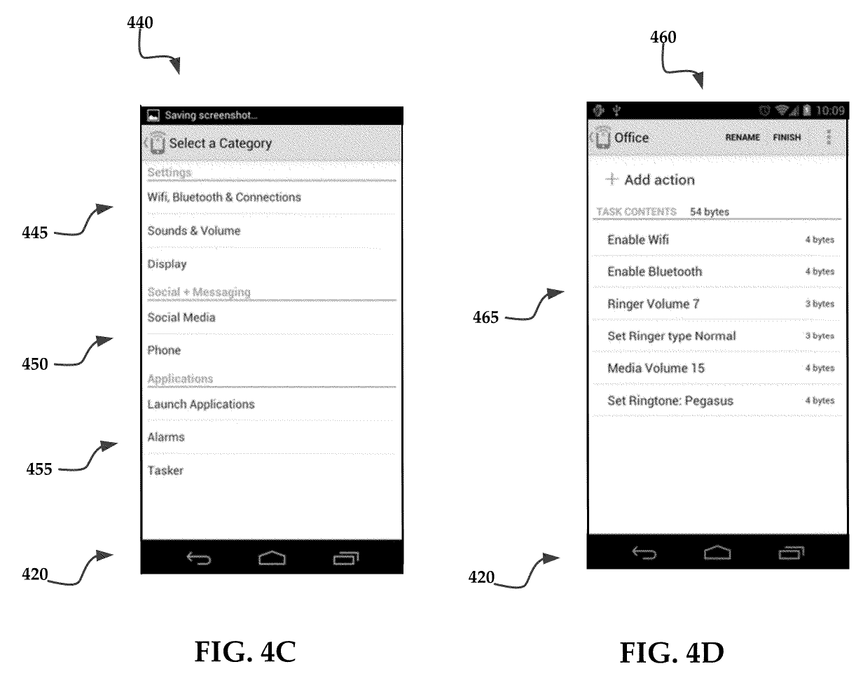

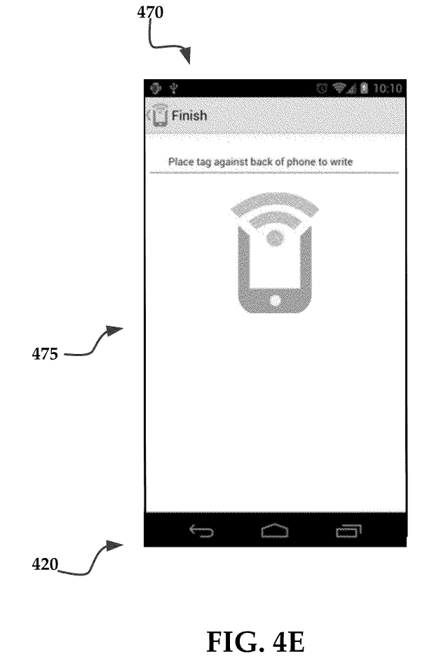

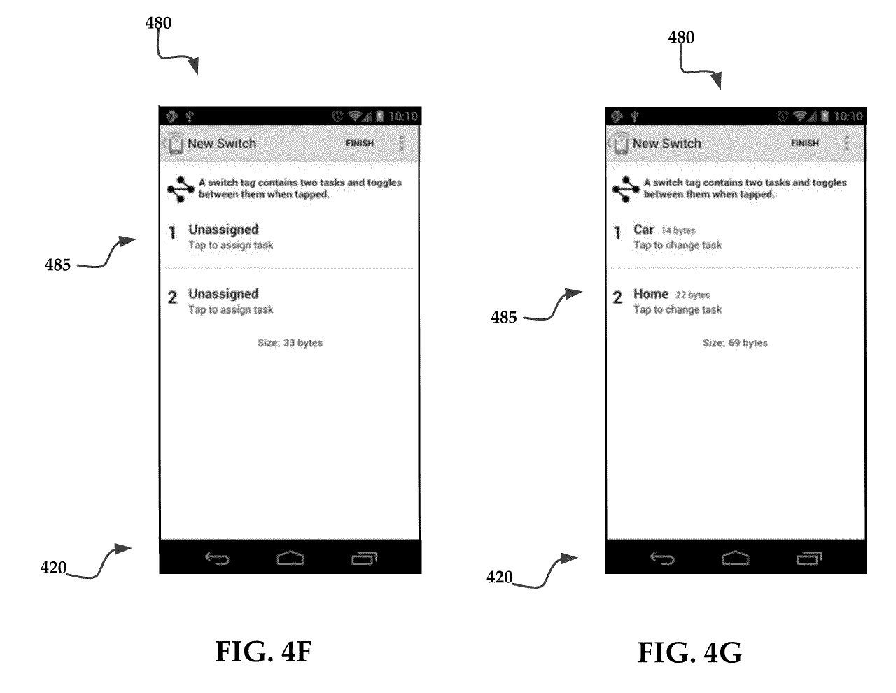

FIG. 4A shows main screenshot 400 which may be displayed on a mobile device running an NFC Task Launcher application, and which may include selection area 405, tag identifier area 410, and navigation buttons 420. Selection area 405 may offer a user a choice between several basic operations, for instance programming a new tag and/or buying new tags. Tag identifier area 410 may include a list of tags read by the mobile device, including a name identifier (for example, office, home and car), and a time when the tag was last read by the mobile device. Navigation buttons 420 may enable a user to navigate NFC Task Launcher, and may include a back button, a home button and a menu button. Navigation buttons 420 may be part of the operating system itself and may vary based on the device and/or operating system being used.

FIG. 4B shows tag selector screenshot 430 which may be displayed on a mobile device running an NFC Task Launcher application. Tag selector screenshot 430 may include tag type selection area 435 and navigation buttons 420. Tag type selection area 435 may offer a user a choice between several tag operations, for instance adding a new task, creating a new switch tag (also referred to as a multiple command tag), creating a new uri (uniform resource identifier), creating a new url (uniform resource locator), creating a new vCard, creating a new message, and/or erasing a tag. Navigation buttons 420 may provide the same functions as previously discussed, or a variation thereof.

FIG. 4C shows action category selector screenshot 440 which may be displayed on a mobile device running an NFC Task Launcher application. Action category selector screenshot 440 may include settings selection area 445, social and messaging selection area 450, applications selection area 455, and navigation buttons 420. Settings selection area 445 may include sub-selections for Wifi, Bluetooth and connections; sounds and volume; and display. Social and messaging selection area 450 may include sub-selections for social media and a phone. Applications selection area 455 may include sub-selections for launching applications, alarms and a task application. Navigation buttons 420 may provide the same functions as previously discussed, or a variation thereof.

FIG. 4D shows tag customizer screenshot 460 which may be displayed on a mobile device running an NFC Task Launcher application. Tag customizer screenshot 460 may include task selection area 465 and navigation buttons 420. Task selection area 465 may include sub-selections for enabling Wifi, enabling Bluetooth, changing a ringer volume, setting a ringer type, changing a media volume, and setting a different ringtone. The tasks in task selection area 465 may be added using an add action button, and the tasks may be added to a tag that is associated with a place, for example an office. Navigation buttons 420 may provide the same functions as previously discussed, or a variation thereof.

FIG. 4E shows tag programmer screenshot 470 which may be displayed on a mobile device running an NFC Task Launcher application. Tag programmer screenshot 470 may include user instruction area 475 and navigation buttons 420. User instruction area 475 may provide instructions for a user to write the selected set of tasks to an NFC tag. For instance, by placing an NFC tag against the back of the phone to write to the NFC tag. Navigation buttons 420 may provide the same functions as previously discussed, or a variation thereof.

FIG. 4F shows switch tag assignment screenshot 480 which may be displayed on a mobile device running an NFC Task Launcher application. Switch tag assignment screenshot 480 may include command assignment area 485 and navigation buttons 420. Command assignment area 485 in FIG. 4F shows a new switch tag assignment, having two task command sets, prior to the assigning of any tasks to the switch tag. Navigation buttons 420 may provide the same functions as previously discussed, or a variation thereof.

FIG. 4G shows switch tag assignment screenshot 480 which may be displayed on a mobile device running an NFC Task Launcher application. Switch tag assignment screenshot 480 may include command assignment area 485 and navigation buttons 420. Command assignment area 485 in FIG. 4G shows a new switch tag assignment, having two task command sets, after the assigning of a first set of tasks, designated “car” to the first set of commands on the switch tag, and a second set of tasks, designated “home” to the second set of commands on the switch tag. Navigation buttons 420 may provide the same functions as previously discussed, or a variation thereof.

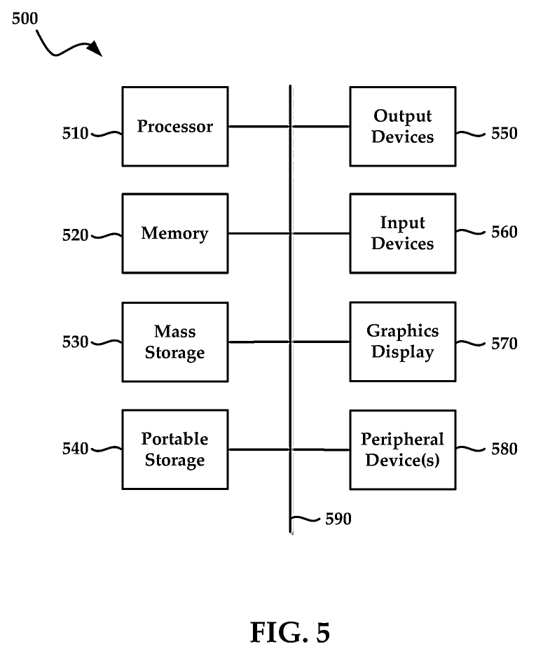

FIG. 5 illustrates an exemplary computing system 500 that may be used to implement an embodiment of the present technology. Mobile device 100, a cloud-based server system distributing an NFC task launcher application, and/or an NFC tag writing system may include one or more of the components of computing system 500. The computing system 500 of FIG. 5 includes one or more processors 510 and memory store 520. Main memory store 520 stores, in part, instructions and data for execution by the one or more processors 510. Main a memory store 520 can store the executable code when the computing system 500 is in operation. The computing system 500 of FIG. 5 may further include a mass storage device 530, portable storage medium drive(s) 540, output devices 550, user input devices 560, a graphics display 570, and other peripheral device(s) 580.

The components shown in FIG. 5 are depicted as being connected via a single bus 590. The components may be connected through one or more data transport means. The one or more processor 510 and main a memory store 520 may be connected via a local microprocessor bus, and the mass storage device 530, peripheral device(s) 580, portable storage medium drive 540, and graphics display 570 may be connected via one or more input/output (I/O) buses.

Mass storage device 530, which may be implemented with a magnetic disk drive or an optical disk drive, is a non-volatile storage device for storing data and instructions for use by processor 510. Mass storage device 530 can store the system software for implementing embodiments of the present technology for purposes of loading that software into main a memory store 520.

Portable storage medium drive(s) 540 operate in conjunction with a portable non-volatile storage medium, such as a floppy disk, compact disk or digital video disc, to input and output data and code to and from the computing system 500 of FIG. 5. The system software for implementing embodiments of the present technology may be stored on such a portable medium and input to the computing system 500 via the portable storage medium drive(s) 540.

Input devices 560 provide a portion of a user interface. Input devices 560 may include an alphanumeric keypad, such as a keyboard, for inputting alphanumeric and other information, or a pointing device, such as a mouse, a trackball, stylus, or cursor direction keys. Additionally, the system 500 as shown in FIG. 5 includes output devices 550. Suitable output devices include speakers, printers, network interfaces, and monitors.

Graphics display 570 may include a liquid crystal display (LCD) or other suitable display device. Graphics display 570 receives textual and graphical information, and processes the information for output to the display device.

Peripherals device(s) 580 may include any type of computer support device to add additional functionality to the computing system. Peripheral device(s) 580 may include a modem or a router.

The components contained in the computing system 500 of FIG. 5 are those typically found in computing systems that may be suitable for use with embodiments of the present technology and are intended to represent a broad category of such computer components that are well known in the art. Thus, the computing system 500 of FIG. 5 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A system implemented by a processor of a mobile device, comprising:
a receiver module for receiving a signal from a near field communication (NFC) tag;
an interface module for processing the signal and identifying at least one action to be performed; and
an action module for performing the at least one action.

2. The system of claim 1, wherein:
the receiver module is further for receiving a second signal from the NFC tag, the second signal being received after the signal and without an intervening signal being received;
the interface module is further for processing the second signal and identifying at least one second action to be performed; and
the action module is further for performing the at least one second action.

3. The system of claim 2, wherein the signal and the second signal comprise identical content.

4. The system of claim 3, wherein the identical content comprises a command corresponding to the at least one action and a second command corresponding to the at least one second action.

5. The system of claim 4, wherein:
the command and the second command are separated by a command syntax break; and
the interface module is further for parsing the identical content into the command and the second command using the command syntax break.

6. The system of claim 5, wherein when the second signal is identified as being received after the signal and without the intervening signal, the action module performs the at least one second action.

7. The system of claim 1, wherein the at least one action comprises at least one of adjusting a setting of the mobile device and executing an application on the mobile device.

8. The system of claim 1, further comprising a programming module for identifying the at least one action and writing a command corresponding to the at least one action to the NFC tag.

9. The system of claim 1, wherein a command corresponding to the at least one action is written to the NFC tag by a second mobile device.

10. A method for controlling a mobile device using a near field communication (NFC) system, comprising:
receiving at a receiver of the mobile device a signal from an NFC tag;
identifying from the signal at least one action to be performed; and
performing the at least one action.

11. The method of claim 10, further comprising:
receiving a second signal from the NFC tag, the second signal being received after the signal and without an intervening signal being received;
processing the second signal and identifying at least one second action to be performed; and
performing the at least one second action.

12. The method of claim 11, wherein the signal and the second signal comprise identical content.

13. The method of claim 12, wherein the identical content comprises a command corresponding to the at least one action and a second command corresponding to the at least one second action.

14. The method of claim 13, wherein:
the command and the second command are separated by a command syntax break; and
the method further comprises parsing the identical content into the command and the second command using the command syntax break.

15. The method of claim 14, wherein when the second signal is identified as being received after the signal and without the intervening signal, the at least one second action is performed.

16. The method of claim 10, wherein the at least one action comprises at least one of adjusting a setting of the mobile device and executing an application on the mobile device.

17. The method of claim 10, further comprising identifying the at least one action and writing a command line comprising the at least one action to the NFC tag.

18. The method of claim 10, wherein a command corresponding to the at least one action is written to the NFC tag by a second mobile device.

19. A non-transitory computer readable medium having recorded thereon a program, the program when executed causing a computer to perform a method, the method for controlling a mobile device using a near field communication (NFC) system, the method comprising:
receiving an input indicating at least one action to be performed when a proximity event is identified, the proximity event being when a receiver of the mobile device is proximate to an NFC tag; and
identifying the proximity event by the receiver of the mobile device; and
performing the at least one action when the receiver identifies the proximity event.

20. The non-transitory computer readable medium of claim 19, further comprising:
receiving a second input indicating at least one second action to be performed when a second proximity event is identified, the second proximity event being when the receiver of the mobile device is proximate to the NFC tag, the second proximity event occurring after the first proximity event and without an intervening proximity event;
identifying the second proximity event by the receiver of the mobile device; and
performing the at least one second action when the receiver identifies the proximity event.
